(19) United States
(12) Patent Application Publication
(10) Pub. No.: US 2019/0224593 A1
(43) Pub. Date: Jul. 25, 2019

(54) SEPARATION VESSEL WITH ENHANCED PARTICULATE REMOVAL

(71) Applicant: KBK Industries, LLC, Rush Center, KS (US)

(72) Inventor: Will Dexter Ball, IV, Bixby, OK (US)

(21) Appl. No.: 16/253,973

(22) Filed: Jan. 22, 2019

Related U.S. Application Data
(60) Provisional application No. 62/620,698, filed on Jan. 23, 2018.

(51) Int. Cl. B01D 21/26; B01D 21/24; B01D 21/00; B01D 17/02; C02F 1/40; C02F 1/38

(52) U.S. Cl. CPC B01D 21/265; B01D 21/2411; B01D 21/2494; B01D 21/0042; B01D 17/0205; C02F 2103/10; B01D 17/0214; B01D 17/0217; B01D 21/2444; C02F 1/40; C02F 1/385; B01D 17/0211

(57) ABSTRACT

A separation tank having an interior space for separating gas and water from oil. A column is disposed in the interior space that has a top portion and a bottom portion, the top portion fluidly connected to an inlet, and the bottom portion fluidly connected to an outlet. The top portion of the column is open to the interior space of the tank through a spiral diffuser which includes a plurality of spiral vanes. An oil collector weir is located in the interior space and is fluidly connected to an oil outlet disposed external to the tank. An upper flow diverting baffle is located below the spiral diffuser and a lower flow diverting baffle is provided below the upper flow diverting baffle so that fluid flows from the spiral diffuser downwardly around the two flow diverting baffles. An aerated water dispensing system is associated with the tank and provides microbubbles to the interior space from the lower flow diverting baffle.

### CROSS-REFERENCE TO RELATED APPLICATIONS

The present application claims the benefit of U.S. Provisional Patent Application Ser. No. 62/620,698, filed on Jan. 23, 2018, which is incorporated herein in its entirety by this reference.

### BACKGROUND OF THE DISCLOSURE

The present disclosure relates to a separation vessel for separating gas, sediment, and water from crude oil for oil production that contains significant amounts of water.

With oil prices hovering around $85-$100/barrel, current economics strongly favor separating and selling every drop of crude oil possible. Water production now dominates many oilfield operations, and too much oil remains entrained in it. The conventional API gun barrel separator tanks are the type of separation vessels that are often used to try to separate that oil. Those tanks were designed to remove small quantities of water from large quantities of oil, not small amounts of oil from large quantities of water. Today's high water cuts suggest that these old industry workhorses may be obsolete when large volumes of water are involved.

The present invention addresses this problem with a more sophisticated, a more complex, and a more expensive type of separator. However, at today's oil prices, the initial cost of installation of this more expensive type of separator is recovered in just a matter of days by the direct benefit of increased oil recovery achieved by this new separator design over the conventional gun barrel vessels currently in use.

Also, there are other indirect cost savings associated with disposal of water effluent from the present invention verses disposal of water effluent from the conventional gun barrel vessel tanks currently in use. The oil that exits with the water effluent from the inefficient conventional gun barrel vessels is disposed of with the water effluent into injection wells or disposal wells. The oil contained in that water effluent has a tendency to plate out on the tubular, the well liner, the well bore and the formation rock of the disposal well. Because the oil is water-insoluble, as it coats the formation face, it begins to restrict or plug the flow of water flowing from the well to the formation. Most of the suspended solids in the water accumulate in this oily material, increasing the volume of the deposit and causing even more plugging. This oily residue tends to build up in the formation within a few feet of the well bore and on the formation face, forming impervious flow paths that eventually cause injection pressures to climb and injection rates to decline.

As injection rates decline, it is common practice to stimulate the disposal well, often using a dilute solution of hydrochloric acid or other common stimulation solvents, usually with added surface active chemical ingredients. After the first stimulation, the result is that the well is returned to near its original injection rate and pressure. However, it is also common that after the first stimulation, injection rates fall off and injection pressures increase more rapidly than before. This situation becomes more severe after each subsequent stimulation effort until a point of diminishing returns is reached. Eventually, when stimulation efforts fail and the disposal well bore is obviously damaged beyond reclamation, it is then necessary to re-drill, sidetrack and recomplete the existing disposal well, or to drill a new disposal well. The costs for these more drastic measures range from $500,000 to $3,000,000. This is the indirect cost of poor water quality in the effluent from the oil water separators that are in use today.

With such staggering direct and indirect costs, it seems prudent to take positive steps to capture and sell as much of the entrained oil as possible in the crude oil stream, and to take steps to prevent well plugging from any and all other sources of contaminants such as solids, bacteria, etc.

One step is to select oil-water separation equipment that actually separates all physically separable oil from the produced water. The goal of the present invention is to provide a 20-30 fold increase in separation efficiency over conventional gun barrel separating tanks. Conventional gun barrel tanks will be only 3-5% hydraulically efficient at separating entrained oil, whereas the present invention is 60-72% hydraulically efficient at separating the entrained oil. The present invention reduces the oil concentration to below 50 ppm in the effluent water as compared to approximately 300-1500 ppm of oil in the effluent water emanating from conventional gun barrel separation tanks.

### BRIEF SUMMARY OF THE DISCLOSURE

In one aspect, the present disclosure describes a separation tank for separating water and particulates from crude oil. The separation tank includes a tank enclosing an interior space. A central column is disposed in the tank, the central column having a top portion and a bottom portion, the top portion fluidly connected to an inlet and the bottom portion fluidly connected to an outlet. The top portion is open to the interior space of the tank through a spiral diffuser, which includes a plurality of spiral vane baffles disposed adjacent to inlet fluid slots and connected along their top to a horizontal quieting upper donut baffle. The bottom portion is open to the interior space through at least one outlet hole. An oil collector weir is disposed adjacent a top of the interior space and is fluidly connected to an oil outlet disposed external to the tank. An upper flow diverting baffle is located below the spiral diffuser and a lower flow diverting baffle is provided below the upper flow diverting baffle so that fluid flows downward within the water section around the two flow diverting baffles. The upper flow diverting baffle has an outer peripheral diameter.

In one embodiment, the separation tank further includes an aerated water dispensing system, which comprises at least one ring shaped conduit disposed adjacent the lower flow diverting baffle around a section of the center column. The at least one ring shaped conduit includes a plurality of openings that are adapted to discharge a stream of aerated water into the tank interior. In one embodiment, the at least one ring shaped conduit has a diameter that is smaller than the outer peripheral diameter of the upper flow diverting baffle.

In another aspect, the disclosure describes a separation tank for separating water from oil. The separation tank includes a tank enclosing an interior space, a central column disposed in the tank, the central column having a top portion and a bottom portion, the top portion fluidly connected to an inlet and the bottom portion fluidly connected to an outlet, wherein the top portion is open to the interior space of the tank through a spiral diffuser and the bottom portion is open to the interior space through at least one outlet hole. An oil collector weir is provided adjacent a top of the interior space and is fluidly connected to an oil outlet disposed external to the tank. An aerated water dispensing system includes: at least one ring shaped conduit disposed around a section of the center column, the at least one ring shaped conduit including a plurality of openings adapted to discharge a stream of aerated water into the tank interior; a pump having an inlet fluidly connected via an inlet conduit with the interior space of the tank and an outlet fluidly connected via an outlet conduit with the at least one ring shaped conduit; and a mixer having an air inlet, the mixer connected between the inlet conduit and the outlet conduit such that air provided through the air inlet of the mixer is entrained into a water stream passing through the mixer from the outlet conduit towards the inlet conduit.

### BRIEF DESCRIPTION OF THE DRAWINGS

FIG. 1 is a diagram of the internal components contained within a separation vessel.

FIG. 2 is a top view of the separation vessel of FIG. 1, showing the arrangement of the various internal components.

FIG. 3 is a top view showing the inlet pipe attached to the center column in an offset manner so that the fluid entering the center column travels in a circular path within the center column.

FIG. 4 is top plan view of the spiral swirl vane diffuser removed from the vessel of FIG. 1.

FIG. 5 is a top perspective view of the spiral swirl vane diffuser of FIG. 4.

FIG. 6 is a bottom perspective view of one of the interface draw offs from FIG. 1.

FIGS. 7 and 8 are views of an embodiment for a separation tank in accordance with the disclosure.

FIG. 9 is a view of an alternative embodiment for a separation tank in accordance with the disclosure,

### DETAILED DESCRIPTION OF THE PREFERRED EMBODIMENT

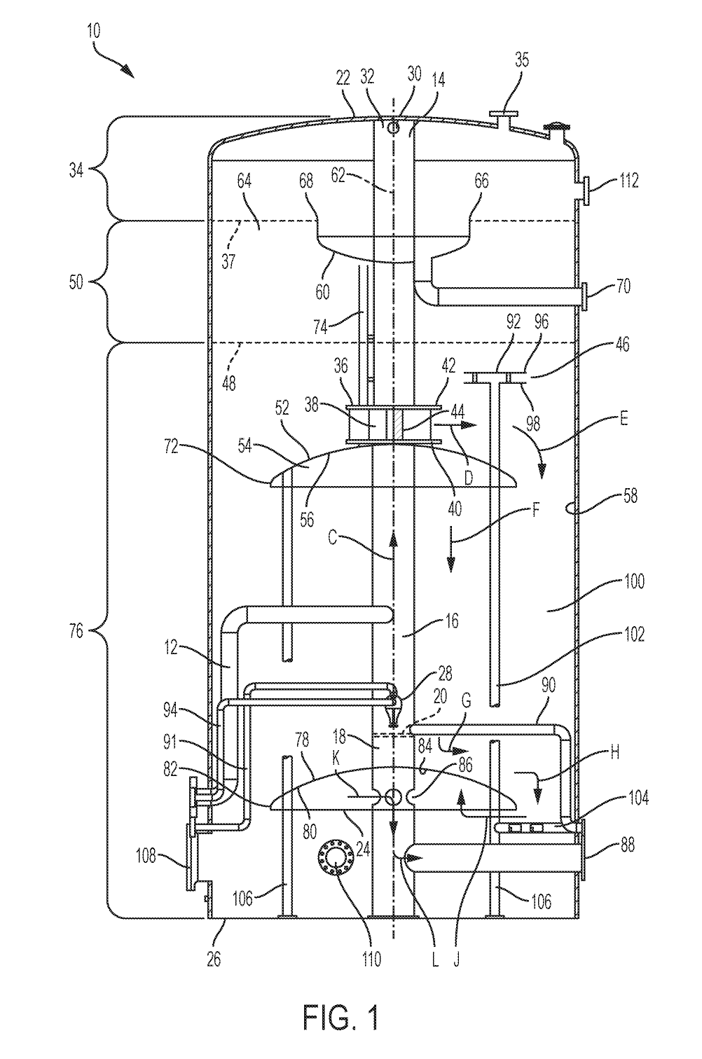

Referring now to the drawings and initially to FIG. 1, there is shown a separation vessel or tank with enhanced particulate removal 10. The tank 10 is designed for separating gas, water and particulates from crude oil.

When the incoming fluid contains gas, the tank 10 is provided with an optional degassing boot (not illustrated) to allow all free gas to separate from the remaining liquid. This avoids the mixing that would occur in the tank 10 if the gas was allowed to enter with the liquids. Also, there may be provided a degassing boot at the top of the center column, or on the top of the tank before the fluid enters the vessel.

The incoming production fluid enters the tank 10 through an inlet pipe 12 into a large diameter vertical pipe provided in the center of the tank 10 that is referred to as the center column 14. Referring now to FIG. 3, the inlet pipe 12 is tangentially attached to the center column 14 in an offset manner so that the fluid enters the center column 14 in a circular path to increase retention time within the center column 14, as shown by Arrows A and B in FIG. 3.

The center column 14 is divided into two vertical sections: the inlet section 16 and the outlet section 18. The inlet and outlet sections 16 and 18 are separated by a blanking plate 20 that is installed within the center column 14 just above a lower flow diverting baffle 24 that is attached to the center column 14. The blanking plate 20 prevents fluid located within the center column 14 from passing directly between the inlet and outlet sections 16 and 18. The inlet section 16 extends from the top 22 of the tank 10 to the blanking plate 20. The outlet section 18 extends from the blanking plate 20 to the bottom 26 of the tank 10. The blanking plate 20 is installed to divide the center column 14 so the inlet fluid cannot flow directly to the outlet section 18 located below.

Heavier particulates entering with the fluid into the inlet section 16 of the center column 14 fall downward within the center column 14 to the blanking plate 20 and are periodically removed via a center column drain 90 provided above the blanking plate 20 or via a solids removal system 28, such as a Tore® solids removal system, that is installed within the center column 14 above the blanking plate 20 or by both means.

Any free gas that disengages from the remaining fluid flows upward within the center column 14 and exits the center column 14 via gas holes 30 provided in the top 32 of the center column 14 and enters into a gas layer 34 located at the top 22 of the tank 10 above the gas-oil interface 37. Excess gas is removed from the tank 10 via a gas vent 35 provided in the top 22 of the tank which is in communication with the gas layer 34 within the tank 10. Although not illustrated, there may be a degassing boot at the top 32 of the center column 14 or on the top 22 of the tank 10.

The fluid flows out of the center column 14 via a spiral swirl vane diffuser 36 installed in the center column 14. The spiral swirl vane diffuser 36 is provided with vertical curved or swirl vane baffles 38. The vertical curved or swirl vane baffles 38 will hereafter be referred to as inlet diverters 38. Each inlet diverter is secured between a horizontal quieting lower donut baffle 40 and a horizontal quieting upper donut baffle 42, with adjacent inlet diverters 38 spaced apart from each other. Inlet fluid slots 44 are provided in the spiral swirl vane diffuser 36 between adjacent inlet diverters 38. The inlet fluid slots 44 communicate with the inlet section 16 of the center column 14 to allow fluid to flow out of the center column 14 between the inlet diverters 38 and into the interior of the tank 10.

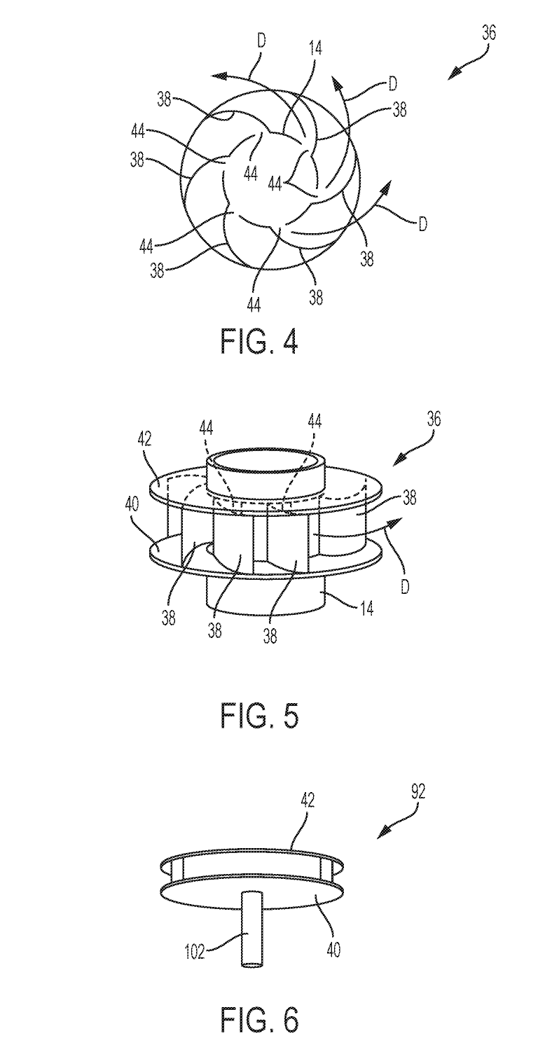

Referring now to FIGS. 1, 4 and 5, the inlet diverters 38 serve to swirl the fluid as it flows out between them. As the fluid exits the center column 14, it turns from a vertical upward direction, as shown by Arrow C, within the center column 14 to a spiraling, horizontal outward direction, as shown by Arrows D, as it exits the center column 14 through the spiral swirl vane diffuser 36 to enter a primary separation zone 46 within the tank 10.

The spiral swirl vane diffuser 36 distributes the fluid within the tank 10 just below the oil-water interface 48 through the diffuser's inlet diverters 38. These inlet diverters 38 are curved to impart a centrifugal force on the liquids, spinning them outward from the center of the tank 10 in an ever increasing radius spiral, as shown by Arrows D. This slows the velocity of the inlet fluid and increases its effective separation time in the primary separation zone 46 just below the oil-water interface 48. As the inlet fluid stream slows, smaller and smaller droplets of oil separate and rise the short distance to the oil layer 50.

Some oil droplets accumulate on the top 52 of the large area upper flow diverting baffle 54 which serves also as a huge surface area coalescer. The upper flow diverting baffle 54 is convex on its upper side or top 52 and is concave on its opposite lower side or bottom 56. As the fluid stream spirals outward away from the center of the tank 10, it encounters the interior tank wall 58 that serves as another large area coalescer. Any droplets of oil attaching themselves to these coalescing surfaces 52 and 58 are no longer in the water, and are now permanently separated from the water. As these surfaces become totally coated with oil, the oil wicks upward, eventually entering the oil layer 50 above, adding to the volume of oil collected in the oil layer 50.

The oil layer 50 is designed to provide adequate time for all accumulating oil to completely dehydrate to typical pipeline specification or better. Uniform oil collection is critical to this function. A very large, concave, circular oil collector 60 provided in the center 62 of the tank 10 at the top 64 of the liquid oil layer 50 assures all oil rises uniformly through the entire oil layer 50, and is collected around 360 degrees of that layer 50. The upper edge 66 of the large oil collector 60 is designed to serve as a very large spillover oil weir 68 for oil. Oil from the oil layer 50 that passes over the oil weir 68 and into the oil collector 60 exits the oil collector 60 and the tank 10 via an oil outlet 70 that is attached to the oil collector 60.

The oil weir 68 is tall. Its height insures a minimum level deviation even during periods of very high incoming fluid slug rates. The level differential between the oil outlet 70 and a downstream tank assures that large flow rates of oil can flow out of the tank's oil collector 60 and oil outlet 70 during slug flow conditions. Because of this, it is nearly impossible to overflow oil from the tank 10.

Once the bulk oil has separated from the main flow of inlet water, the water must turn 90 degrees downward, as shown by Arrow E, to flow down between the upper flow diverting baffle 54 and the tank wall 58. This causes a small measure of acceleration. As the downward flowing water reaches the outer edge 72 of the upper flow diverting baffle 54, it enters a quadrant of the tank 10 which is open to full diameter flow. The acceleration velocity creates a mild eddy current that pulls a portion of the water in and under the upper flow diverting baffle 54. At this point, all fluid flow changes to vertically downward, as shown by Arrow F, through the entire cross sectional area of the tank 10. Velocity is now at its slowest, allowing the smallest of oil droplets to counter flow upward. These droplets rise, coating the concave bottom 56 of the upper flow diverting baffle 54. Once the bottom 56 is coated, the oil can migrate directly into the oil layer located above through a pipe or oil conduit 74 that extends from the bottom 56 of the upper flow diverting baffle 54 up into the oil layer 50 located just below the oil collector 60, thus preventing re-entrainment of oil in the water layer 76. This adds even more to the volume of oil collected and to the separation efficiency of the tank 10.

As the clarified water travels downward and nears the bottom 26 of the tank 10, it encounters the lower flow diverting baffle 24 which is a second large area on which oil can condense. Like the upper flow diverting baffle 54, the lower flow diverting baffle 24 is convex on its upper side or top 78 and is concave on its lower side or bottom 80. As the downward flowing water impinges on the top 78 of this lower flow diverting baffle 24, oil droplets accumulate on its top 78, further enhancing separation. Additionally, as shown by Arrow G, this lower flow diverting baffle 24 forces the flow stream to change directions from vertically downward to nearly horizontal again as the fluid turns to flow around the lower flow diverting baffle 24.

Now the water is flowing straight toward the inside surface or wall 58 of the tank 10 again. As it contacts the tank wall 58, some of the smallest oil droplets impinge on the tank wall 58, coating the wall 58 and are wicked up into the oil layer 50 above. Once again, separation efficiency is enhanced.

In order to exit the tank 10, as shown by Arrow H, the water must turn downward again to flow between the outer edge 82 of the lower flow diverting baffle 24 and the tank wall 58. Since this area is a fraction of the tank cross section, the water must again increase in velocity as it turns downward. Any solids in the water at this point are now aimed directly at, and are being propelled directly toward, the bottom 26 of the tank 10.

As shown by Arrow J, when the water reaches the outer edge 82 of the lower flow diverting baffle 24 it must turn upward more than 90 degrees and flow upward under the concave bottom 80 of the lower flow diverting baffle 24. As the solids are heavier than water, they are less inclined to follow the water flow upwardly and thus separate from the water flow and settle to the bottom of the tank 10. The water flows along the bottom 80 of the lower flow diverting baffle 24 where the tiniest droplets of oil have another chance to coalesce and attach to the very large surface of the bottom 80. Oil accumulating on the bottom 80 of the lower flow diverting baffle 24 is allowed to exit through oil-dedicated weep holes 84 provided extending through the top 78 of the lower flow diverting baffle 24. That oil exits to the area under the upper flow diverting baffle 54, migrates upward until it contacts the bottom 56 of the upper flow diverting baffle 54 and then flows through the oil conduit 74 directly into the oil layer 50.

The water flowing under the lower flow diverting baffle 24 now reaches the center 62 of the tank 10 and enters the outlet section 18 of the center column 14 via outlet holes 86. The outlet holes are provided in the center column 14 just below the blanking plate 20 and below the lower flow diverting baffle 24. As shown by Arrow K, once the water enters the center column 14 through the outlet holes 86, it turns downward and flows down within the center column 14. As shown by Arrow L, from the center column 14, the water then turns horizontally to enter a horizontal water outlet pipe 88 which directs the water out of the tank 10 and into an adjustable height water leg that serves to regulate the height of the oil-water interface 48 located within the tank 10.

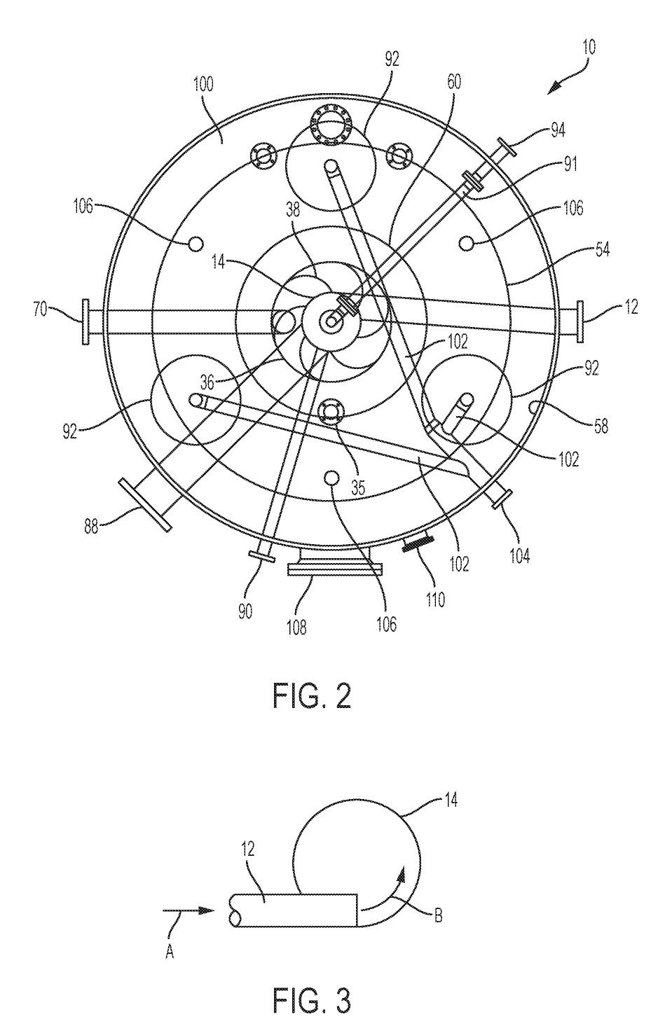

Referring to FIGS. 1 and 2, the separation tank 10 is fitted with two internal tank drains. The first internal tank drain is the center column drain 90 that is located near the solids removal system 28. The second internal tank drain is the set of interface draw offs 92.

The center column drain 90 is the first internal tank drain. Incoming fluid entering the tank 10 often contains some solids. These solids will accumulate preferentially above the blanking plate 20. The center column drain 90 is provided so the operator can drain this area. It should be drained frequently until the water leaving the drain 90 runs clear.

In order to drain the solids that accumulate above the blanking plate 20, it may also be desirable, in addition to the center column drain 90, to include a solids removal system 28, such as the Tore® solids removal system 28 to aid the center column drain 90 in removing solids from the inlet section 16 of the center column 14. A Tore® solids removal system 28 is a solids hydro-transportation device that utilizes the natural power of a motive fluid, such as water, to mobilize and transport solids, liquids or slurries. Tore® systems 28 are available from PDL Solutions Ltd. located in the United Kingdom. The Tore® solids removal system 28 includes a water inlet 94 that feeds water to the Tore® solids removal system 28 and a water and solids outlet 91 that drains a mixture of water and solids out of the inlet section 16 of the center column 14.

Referring also to FIG. 6, the interface draw offs 92 collectively constitute the second internal tank drain. As oil accumulates in the tank 10, it is common that some BS&W (basic sediment and water, which is also referred to as “emulsion”) will accumulate immediately below or at the oil-water interface 48. The BS&W is heavier than pure oil because of the water and solids contained in it. Therefore, the emulsion will build downward from the level of the normal oil-water interface 48. Several interface draw offs 92 are provided in the tank 10 about a foot below the normal oil-water interface 48. Each interface draw offs 92 is constructed of an upper round horizontal draw off baffle 96 and a lower round horizontal draw off baffle 98, with each draw off baffle 96 and 98 being approximately 24 inch in diameter. The upper draw off baffle 96 is stacked on top of the lower draw off baffle 98 of each interface draw off 92 and the two draw off baffles 96 and 98 are spaced approximately 4 inches apart. The area between the upper and lower draw off baffles 96 and 98 is open to the interior 100 of the tank 10. A draw off pipe 102 is connected to each of the lower draw off baffles 98, and the individual draw off pipes 102 are connected together and piped to a convenient elevation near the bottom of the tank 10 where the pipe exits the tank 10 as the BS&W interface drain 104. A BS&W valve (not illustrated) is installed to open and close the BS&W interface drain 104. When the BS&W valve on the BS&W interface drain 104 is opened, the BS&W layer flows horizontally between the upper and lower draw off baffles 96 and 98 of each interface draw off 92 and out of the tank 10 through the BS&W interface drain 104. When either clean water or clean oil is observed in the sample of the outlet fluid, the BS&W has been removed and the BS&W valve can then be closed.

The upper and lower flow diverting baffles 54 and 24 and the interface draw offs 92 are supported within the tank 10 by support legs 106 that extend down to the bottom 26 of the tank 10.

The tank 10 is provided with a cleanout man way 108 for providing access to the interior 100 of the tank 10 when it is out of service and also a heater man way 110 for installation of an immersion heater (not illustrated) within the tank 10.

Although not specifically illustrated, sand removal systems can also be included in the bottom of the tank 10. These should be drained daily until clean water is observed.

Although not illustrated, a water leg will be installed on site with the tank 10 as a means of regulating the fluid levels. The water leg is a pipe within a pipe. The clarified water enters through the outer pipe and turns upward where it flows in the annular space between the two pipes. The inner pipe is sized for its circumference. The circumference of the outer pipe forms a spillover weir for the water with the inner pipe. The height of the top of the inner pipe establishes the weir that sets the level of the oil-water interface 48 inside the separation tank 10. The height of this weir is critical. It is always adjustable, either by removing an upper removable center pipe nipple, or via an external adjustment assembly that slides a movable upper section of the inner pipe up and down to change its spillover elevation.

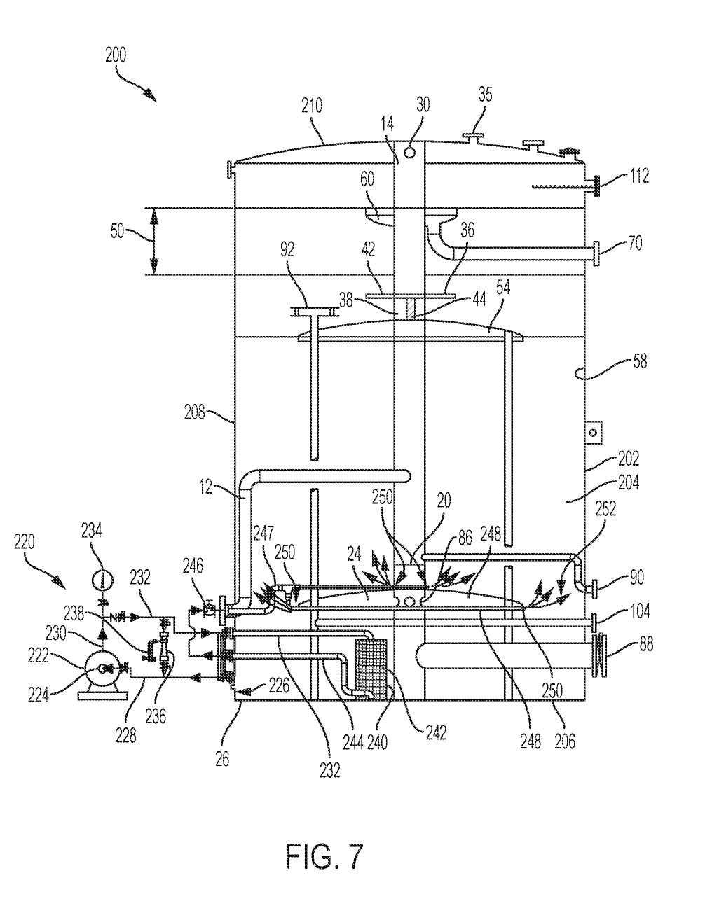

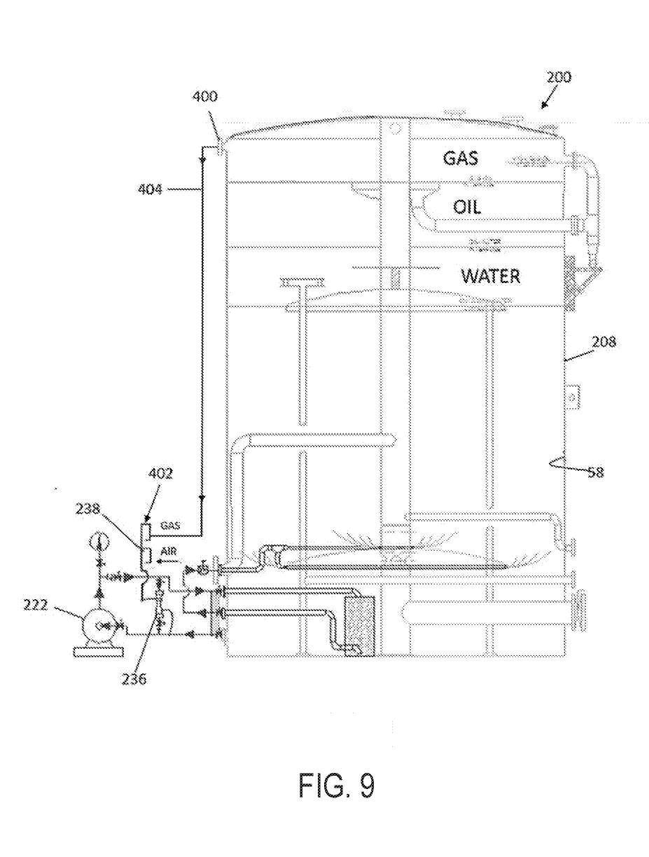

An alternative embodiment of a tank 200 is shown in FIG. 7, and a variation of the tank 200 is shown in FIG. 9. In the description that follows, certain structures and features that are the same or similar to corresponding structures and features previously described are denoted by the same reference numerals previously used for simplicity. The tank 200 includes a tank wall 202 that encloses an internal tank space 204. The tank wall 202 includes a circular floor 206, a cylindrical sidewall 208 and a domed cap 210, each of which may include various openings for the passage of fluids therethrough, as required.

The tank 200 is generally structured similar to the tank 10 with a few notable differences. For example, the inlet diverters 38 that surround the inlet fluid slots 44 are engaged along their top with the horizontal quieting upper donut baffle 42 but the lower donut baffle 40 of tank 10 has been removed in tank 200 such that inlet fluid and, specifically, the water included therewith, begins sinking towards the bottom along the top surface of the upper flow diverting baffle 54 immediately upon discharge of the inlet fluid slots 44 of the center column 14. Also, a gas outlet 400 fluidly communicates with the top of the tank interior.

Additionally, the tank 200 includes an aerated water dispensing system 220, which enhances the separation efficiency of the tank 200 as compared to the tank 10 by providing aerated water under pressure into the internal tank space 204. The air diluted in the aerated water thus provided creates micro bubbles that can attach to oil droplets that are 30 microns or less and are mixed with the water in the lower portions of the interior tank space 204. These air bubbles, which use the oil droplets as germination sites to form from the air-saturated water, attach themselves to the oil droplets and thus increase the buoyancy of these small oil droplets and carry them towards the top of the internal tank space and into the oil layer 50.

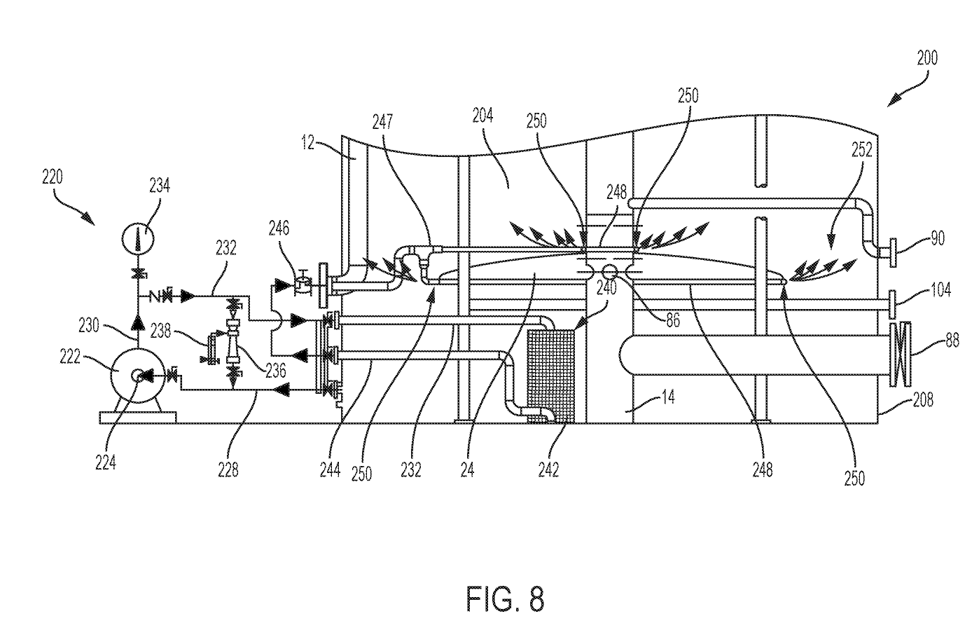

In the embodiment illustrated in FIG. 7, the aerated water dispensing system 220 draws water from the tank 200, adds air into the water drawn, and provides the aerated water back into the tank to help extract fine oil droplets from the water, as described above. In the variation shown in FIG. 9, the aerated water dispensing system 220 can selectively draw controllable portions of air and/or gas from the top of the tank, which is added to the water drawn and provided back in the tank. More particularly, and in further reference to the enlarged detail view of FIG. 8, the aerated water dispensing system 220 includes a pump 222 having an inlet 224 that is fluidly in communication with an inlet port 226 of the tank sidewall 208 via an inlet conduit 228. The inlet port 226 is located at a height above the bottom 206 of the tank to discourage ingestion of sand in the pump 222 during operation. The pump 222, which may be operated by an electric motor (not shown) or another appropriate motive source, draws a flow of water from the tank 200 through the inlet conduit 228 during operation, pressurizes the water, and provides pressurized water at a pump outlet 230. The pump outlet 230 is connected to an outlet conduit 232, which may also include a pressure monitor 234.

During operation, a pressure difference is provided across the pump inlet and outlet 224 and 230, which is also present across the inlet and outlet conduits 228 and 232. This pressure difference, in the illustrated embodiment, is used to draw a flow of air and mix it with the flow of water, but other arrangements can be used. As shown in FIGS. 7 and 8, a mixing conduit includes a mixer 236, which operates on a venturi principle to introduce or entrain a controlled amount of air into a flow of water passing through a central portion of the mixer 236. The airflow into the mixer 236 is controlled and measured by a rotameter 238. In the embodiment of FIG. 7, the rotameter 238 is the only input to the mixer 236. In the embodiment of FIG. 9, a second rotameter 402 can selectively also provide gas from the tank interior to the mixer 236. As shown in FIG. 9, the second rotameter 402 is fluidly connected to the tank interior through the gas outlet 400, via a gas line 404. As the mixer 236 introduces air and/or gas into the water at the inlet conduit 228, the air, gas, or a mixture of air and gas is premixed with the water flow at the mixer and also as the air and/or gas and water together pass through the pump 222. The premixed air air/or gas and water provided at the outlet conduit 232 may also pass through a pressure regulator and are routed into a pressurized canister 240 for further mixing of the air/gas and water into an air/gas saturated water flow.

In the illustrated embodiment, the canister 240 is filled with media that operates to mix the air/gas and water. As shown, the canister 240 is disposed within the tank, although external mounting is also contemplated, and is filled with ceramic saddles 242. During operation, water and air/gas from the outlet conduit 232 are provided through the top of the canister 240 and pass therethrough in a downward direction along a tortious path that dilutes the air and/or gas into the water to form an aerated water mixture. The amount of air/gas introduced into the water may be selected to be at or below an air/gas saturation point for the water at the then current temperature and pressure.

The aerated water flow exits the canister 240 through its bottom and is routed through an aerated water supply conduit 244, which also includes a valve 246 such as a diaphragm valve 246, into a distribution network 247 disposed within the tank. The aerated water will depressurize when introduced into the tank environment and will spawn bubble formation that will capture fine oil droplets and raise them towards the top of the tank. For this reason, the aerated water is introduced towards the bottom of the tank. In the illustrated embodiment, the distribution network includes perforated pipes attached to the lower diverting baffle 24. As shown, two ring-shaped conduits 248 are disposed peripherally around certain sections of the lower diverting baffle 24. An upper conduit 248 is disposed along the apex of the upper, convex surface of the lower diverting baffle 24, around the center column 14. A lower conduit 248 is disposed along an outer periphery of the upper, convex surface of the lower diverting baffle 24. Each conduit 248 includes one or more openings 250 that allow aerated water from within the conduit 248 to be introduced into the internal tank space 204. Fewer or more than two conduits 248 may be used. The aerated water is provided as a discharge 252 into the tank interior 204.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A separation tank for separating fluids comprising:
a tank enclosing an interior space;
an inlet pipe adapted to introduce a fluid mixture into the interior space of the tank where the fluid mixture separates into a gas, which collects in a gas layer at the top of the interior space, and into an oil layer and a water layer, which oil and water layers collect within the interior space below the gas layer, and wherein an interface is defined between each layer;
a vertical column disposed in the interior space, the vertical column having a first interior portion and a second interior portion, the first and second interior portions being separated by a plate disposed within the column, and wherein the first interior portion of the column is fluidly connected to the inlet pipe, the inlet pipe being offset with respect to the vertical column such that fluid flowing through the inlet pipe enters the first interior portion of the vertical column in a circular swirling fashion;
means for removing particulate matter from the first interior portion of the vertical column;
a swirl vane diffuser associated with the vertical column and disposed above the inlet pipe such that fluid flows out of the first interior portion of the column through the swirl vane diffuser and into the interior space of the tank in an outward spiral;
an outlet for discharging gas from the gas layer of the interior space of the tank;
an upper flow diverting baffle associated with the column and disposed in the interior space of the tank below the swirl vane diffuser;
an oil collector including a weir for skimming and collecting oil from the oil layer, the oil collector disposed above the upper flow diverting baffle so as to be near the interface between the gas and oil layers, and wherein the oil collector is fluidly connected to an oil outlet such that oil may flow from the oil collector through the oil outlet and out of the tank;
a lower flow diverting baffle associated with the column and disposed below the upper flow diverting baffle so as to be in the water layer of the interior space of the tank;
an interface draw-off located so as to be near the top of the water layer and below the interface between the oil and water layers, the interface draw-off communicating with a draw-off pipe that is connected to a tank outlet;
an aerated water dispensing system to introduce a multiplicity of bubbles into the water layer of the tank;
an outlet hole in the vertical column below the lower flow diverting baffle to permit fluid to flow from the water layer into the second interior portion of the vertical column; and
an outlet pipe fluidly connected to the second interior portion of the vertical column so that fluid can exit the tank therethrough.

2. The separation tank of claim 1 operably associated with an adjustable water leg that controls a height of the interface between the oil and water layers.

3. The separation tank of claim 1 wherein the interface draw-off comprises an upper substantially horizontal baffle and a lower substantially horizontal baffle defining a space therebetween, and in which the space between the upper and lower baffles is open to the water layer of the tank and connected to the draw-off pipe.

4. The separation tank of claim 1 wherein each of the upper and lower flow diverting baffles has an upper side and a lower side.

5. The separation tank of claim 4 wherein the upper side of each of the upper and lower flow diverting baffles is convex, and the lower side of each of the upper and lower flow diverting baffles is concave.

6. The separation tank of claim 5 wherein the lower flow diverting baffle has a weep hole therethrough so that oil accumulating on the lower side of the lower flow diverting baffle may flow through the weep hole to migrate upwardly within the tank.

7. The separation tank of claim 6 in which a conduit is provided from the lower side of the upper flow diverting baffle to the oil layer so that oil which migrates upwardly within the interior space of the tank to the lower side of the upper flow diverting baffle flows through the oil conduit to the oil layer.

8. The separation tank of claim 1 wherein the lower flow diverting baffle is located below the plate separating the first and second interior portions of the vertical column.

9. The separation tank of claim 1 wherein the swirl vane diffuser has an upper baffle and a lower baffle and a plurality of curved vanes sandwiched therebetween to impart the spiral flow to fluid flowing through the spiral vane diffuser.

10. The separation tank of claim 4, wherein the aerated water dispensing system comprises:
a pump configured to pressurize water, the pump fluidly connected to the tank so as to draw water from the water layer;
a fluid conduit to receive the pressurized water from the pump;
a mixer associated with the fluid conduit to aerate the pressurized water with one of ambient air, gas from the gas layer of the tank, and a combination of ambient air and gas from the gas layer of the tank; and
a distribution network fluidly connected to the fluid conduit to introduce the aerated pressurized water to the water layer of the tank.

11. The separation tank of claim 10 wherein the distribution network includes a perforated pipe attached to the upper side of the lower flow diverting baffle.

12. The separation tank of claim 11 in which the perforated pipe of the distribution network is circular in shape.

13. The separation tank of claim 10, wherein the mixer includes a rotameter to control the aeration of the pressurized water received from the pump.

14. The separation tank of claim 10, wherein the aerated water dispensing system further comprises a pressurized collection canister connected to the fluid conduit upstream of the distribution network.

15. The separation tank of claim 14, wherein the pressurized canister contains a medium that facilitates the aeration of the pressurized water delivered to the distribution network.

16. The separation tank of claim 11, in which the lower flow diverting baffle has a peripheral edge between its upper side and its lower side, and in which the distribution network includes a second perforated pipe located at the peripheral edge.

17. A separation tank for separating fluids comprising:
a tank having a tank wall enclosing an interior space;
an inlet pipe adapted to introduce a fluid mixture into the interior space of the tank where the fluid mixture separates into a gas, which collects in a gas layer at the top of the interior space, and into an oil layer and a water layer, which oil and water layers collect within the interior space below the gas layer;
an upper flow diverting baffle disposed in the interior space;
a lower flow diverting baffle disposed in the interior space below the upper flow diverting baffle, the lower flow diverting baffle having a top surface and a bottom surface; and
an aerated water dispensing system to introduce a multiplicity of bubbles into the water layer of the tank, the aerated water dispensing system comprising:
a pump for pressurizing water having a pump inlet and a pump outlet;
an inlet port disposed along the tank wall so as to be adjacent the water layer in the interior space, the inlet port being fluidly connected with the interior space such that fluid may flow from the water layer to the inlet port;
an inlet conduit connecting the inlet port and the pump inlet;
an outlet conduit connected to the pump outlet, the outlet conduit disposed so as to be adjacent the water layer to fluidly connect the pump outlet to the water layer in the interior space;
a mixer associated with the outlet conduit to aerate pressurized water from the pump with one of ambient air, gas from the gas section of the tank, and a combination of ambient air and gas from the gas section of the tank; and
a distribution network fluidly connected to the outlet conduit and located in the interior space so as to introduce the aerated pressurized water to the water layer.

18. The separation tank of claim 17 wherein the distribution network includes a perforated pipe attached to the top surface of the lower diverting baffle.

19. The separation tank of claim 18, in which the lower diverting baffle has a peripheral edge between the top surface and the bottom surface, and wherein the distribution network includes a second perforated pipe located at the peripheral edge of the lower diverting baffle.
